(19) United States
(12) Patent Application Publication
(10) Pub. No.: US 2018/0370048 A1
(43) Pub. Date: Dec. 27, 2018

(54) ROBOT ARM MECHANISM

(71) Applicant: LIFE ROBOTICS INC., Tokyo (JP)

(72) Inventors: Woo-Keun YOON, Tokyo (JP); Hiroaki Matsuda, Tokyo (JP)

(21) Appl. No.: 16/047,658

(22) Filed: Jul. 27, 2018

Related U.S. Application Data
(63) Continuation of application No. PCT/JP2017/002230, filed on Jan. 24, 2017.

(30) Foreign Application Priority Data
Jan. 30, 2016 (JP) 2016-016763

(51) Int. Cl. B25J 19/06; B25J 9/00; B25J 9/04

(52) U.S. Cl. CPC B25J 19/06; B25J 9/102; B25J 9/045; B25J 9/0009

(57) ABSTRACT

In a robot arm mechanism, a column section is rotatably supported on a base, a rise/fall section is placed on the column section, an arm including expansion and contraction properties is supported by the rise/fall section to be capable of raising and lowering, and a wrist section to which an end effecter is fittable is mounted to a tip of the arm. In the rise/fall section, an intake port is provided in a front part and an exhaust port is provided in a rear part, separately, and in the wrist section, an intake port is provided at a side close to the end effecter, and an exhaust port is provided at a side far from the end effecter, separately.

### CROSS-REFERENCE TO RELATED APPLICATIONS

This application is a continuation application of International Patent Application No. PCT/JP2017/002230 filed on Jan. 24, 2017, which is based upon and claims the benefit of priority from the prior Japanese Patent Application No. 2016-016763, filed Jan. 30, 2016 the entire contents of which are incorporated herein by reference.

### FIELD

An embodiment of the present invention relates to a robot arm mechanism.

### BACKGROUND

In recent years, environments where robots are present in the same space as users have been increasing. The possibility of the situation where robots work in the vicinity of workers is being considered for not only for nursing robots but also for industrial robots. If the situation is realized, for example, handicapped persons can work similarly to non-handicapped persons.

The structural features without elbow joints and singularities of the vertical articulated arm mechanism including the linear extension and retraction joint the practical application of which has been realized by the inventors promote the environment where robotic apparatuses work in corporation with workers. A robot aiming to cooperate with workers is required to have a high level of safety from various viewpoints. For example, it is preferable to cover structures such as arms and joint mechanisms with a housing and a bellows, construct an outer surface as flat as possible, and avoid situations where the arms catch the clothing or the like of nearby workers as much as possible.

Further, an intake and exhaust system that takes in outside air and releases the air to outside after passing the air through an internal space is adopted for countermeasures against heat with joint motors, electronic equipment and the like as heating sources, and for this purpose, air intake and exhaust ports are formed in the housing. In designing the position of the intake and exhaust ports, it is required not only to consider the influence on a workpiece held by an end effecter, but also to avoid a situation where clothing of nearby workers is sucked in.

### SUMMARY OF INVENTION

A purpose of the present invention is to minimize an influence on a workpiece and favorably avoid a situation where clothing or the like of a nearby worker is sucked in, in a robot arm mechanism including intake and exhaust ports.

A robot arm mechanism according to the present embodiment is such that a column section is rotatably supported on a base, a rise/fall section is placed on the column section, an arm including expansion and contraction properties is supported by the rise/fall section to be capable of raising and lowering, and a wrist section to which an end effecter is fittable is mounted to a tip of the arm. In the rise/fall section, an intake port is provided in a front part and an exhaust port is provided in a rear part, separately, and in the wrist section, an intake port is provided at a side close to the end effecter, and an exhaust port is provided at a side far from the end effecter, separately.

### BRIEF DESCRIPTION OF THE VIEWS OF THE DRAWING

FIG. 1 is a perspective view illustrating external appearance of a robot arm mechanism according to the present embodiment;

FIG. 2 is a detailed view of a column section in FIG. 1;

FIG. 3 is a view of the column section in FIG. 2 seen from a rear;

FIG. 4 is a detailed view of a rise/fall section in FIG. 1:

FIG. 5 is a detailed view of a wrist section in FIG. 1;

FIG. 6 is a view of the wrist section in FIG. 5 seen from an attaching section side for an end effecter; and

FIG. 7 is a view of the wrist section in FIG. 5 seen from a side.

### DETAILED DESCRIPTION

Hereinafter, a robot arm mechanism according to the present embodiment will be described with reference to the accompanying drawings. In the following description, the same reference numerals denote components having substantially identical functions and structures, and the repeated description thereof is made only when necessary.

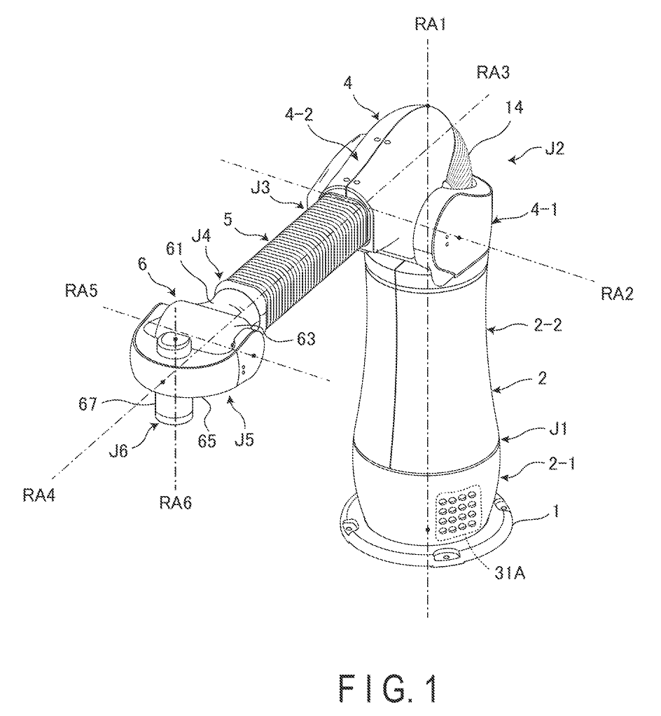

FIG. 1 is a perspective view illustrating external appearance of the robot arm mechanisms according to the present embodiment. The robot arm mechanism has a plurality, six herein, of joints J1, J2, J3, J4, J5 and J6. The first joint J1 includes an axis of torsional rotation RA1. The axis of rotation RA1 is parallel with a vertical direction. The second joint J2 includes an axis of bending rotation RA2. The axis of rotation RA2 is a horizontal axis orthogonal to the axis of rotation RA1. The second joint J2 is set to be offset in two directions with respect to the first joint J1, for example, so that the axis of rotation RA2 does not intersect the axis of rotation RA1 of the first joint J1. The third joint J3 includes an axis of movement RA3. The axis of movement RA3 is orthogonal to the axis of rotation RA2, and is also orthogonal to the axis of rotation RA1 in a state where an arm section 5 described later is kept horizontal. The third joint J3 is set to be offset in two directions with respect to the second joint J2, for example, so that the axis of movement RA3 does not intersect the axis of rotation RA2 of the second joint J2. The fourth joint J4 includes an axis of torsional rotation RA4. The axis of rotation RA4 coincides with the axis of movement RA3. The fifth joint J5 includes an axis of bending rotation RA5. The axis of rotation RA5 is orthogonal to the fourth axis of rotation RA4. The sixth joint J6 includes an axis of torsional rotation RA6. The axis of rotation RA6 is orthogonal to the fifth axis of rotation RA5.

The robot arm mechanism is of a vertical articulated type, and includes a base 1, a column section 2, a rise/fall section 4, the arm section 5 and a wrist section 6. The column section 2, the rise/fall section 4, the arm section 5 and the wrist section 6 are arranged in order from the base 1. The plurality of joints J1, J2, J3, J4, J5 and J6 are arranged in order from the base 1. The column section 2 is installed on the base 1. The column section 2 is constituted of a lower section 2-1 (a fixed section) and an upper section 2-2 (a rotating section). The lower section 2-1 is covered with a housing that is a bottomed cylindrical body. The upper section 2-2 is covered with a housing that is a cylindrical body. The column section 2 houses the first joint J1. A fixed section of the first joint J1 is connected to the lower section 2-1. A rotating section of the first joint J1 is connected to the upper section 2-2. In an internal hollow of the column section 2, a first and second connection piece strings that will be described later are individually housed respectively along the axis of rotation RA1 in a state where the first and second connection piece strings are separated from each other. By rotation of the first joint J1, the wrist section 6, the arm section 5 and the rise/fall section 4 rotate horizontally (laterally) around the axis of rotation RA1 with respect to the lower section 2-1 (the base 1) with the upper section 2-2 of the column section 2. A motor that drives the first joint J1 and a motor driver that controls the motor are housed in a lower portion of the cylindrical housing of the upper section 2-2.

The rise/fall section 4 is placed on the column section 2. The rise/fall section 4 is constituted of a rear section 4-1 (a fixed section) and a front section 4-2 (a rotating section). The rear section 4-1 is covered with a saddle-shaped housing, and is connected to the upper section 2-2 of the column section 2. The front section 4-2 is covered with a cylindrical housing. The rise/fall section 4 forms a continuous hollow structure with the column section 2. The rise/fall section 4 houses the second joint J2. A fixed section of the second joint J2 is connected to the rear section 4-1. A rotating section of the second joint J2 is connected to the front section 4-2. By rotation of the second joint J2, the wrist section 6 and the arm section 5 is raised and lowered up and down with respect to the rear section 4-1 with the front section 4-2. A space between a rear end of the cylindrical housing of the front section 4-2 and an upper end of the saddle-shaped housing of the rear section 4-1 is covered with a cover. A width of the above described space varies with raising and lowering motions of the second joint J2, so that the cover can be a cover that extends and retracts in accordance with a variation of the width of the space. A motor that drives the second joint J2 and a motor driver that controls the motor are housed in the cylindrical housing of the front section 4-2 of the rise/fall section 4.

The third joint J3 is constituted of a linear extension and retraction mechanism. The linear extension and retraction mechanism includes a structure that is newly developed by the inventors, and is clearly distinguished from a so-called linear joint. A fixed section (an ejection section) of the third joint J3 is installed in the front section 4-2 of the rise/fall section 4, and is connected to the rotating section of the second joint J2. A movable section (the arm section 5) of the third joint J3 extends and retracts longitudinally with respect to the fixed section of the third joint J3 in a state where the movable section keeps linear rigidity along the axis of movement RA3. The arm section 5 is covered with a bellows cover having expansion and contraction properties. A rear end of the bellows cover is attached to a front opening of the rise/fall section 4, and a front end is attached to a rear end of the wrist section 6. The bellows cover extends and retracts by following extension and retraction in a longitudinal direction of the arm section 5. A motor that drives the third joint J3 and a motor driver that controls the motor are housed in the rise/fall section 4.

The arm section 5 constituting the linear extension and retraction mechanism has a first connection piece string and a second connection piece string. The first connection piece string is constituted of a plurality of first connection pieces that are bendably connected. The first connection piece is formed in a substantially flat plate shape. The second connection piece string is constituted of a plurality of second connection pieces that are bendably connected. The second connection piece is formed in a groove-shaped body which is U-shaped or channel-shaped in cross section. The leading first connection piece of the first connection piece string is connected to the leading second connection piece of the second connection piece string. The rise/fall section 4 houses a fixed section (an ejection section) in a square tube shape in the front section 4-2. The ejection section is disposed so that a center axis of the ejection section corresponds to the axis of movement RA3. The ejection section constitutes the columnar arm section 5 by joining the first and second connection piece strings, and supports the arm section 5 vertically and laterally. A drive gear is installed behind the ejection section. The drive gear is connected to the motor via a speed reducer or the like. In the first connection piece, a linear gear is formed along a connecting direction in a width center of a rear surface of the first connection piece. The drive gear is meshed with the linear gear of the first connection piece.

The first and second connection piece strings are housed in a storage section in the hollow portion formed by the column section 2 and the rise/fall section 4, in a state where the arm section 5 is retracted. When the drive gear rotates forward, the arm section 5 extends. When the arm section 5 extends, the first connection piece string and the second connection piece string are guided to a rear end opening of the ejection section. The first and second connection piece strings which are guided to the ejection section are pressed in the ejection section, are joined to each other, and constitute a columnar rod body (hereinafter, referred to as a columnar body or the arm section 5). The columnar body by joining of the first and second connection piece strings is firmly held by the ejection section, and thereby a joined state of the first and second connection piece strings is kept. When the joined state of the first and second connection piece strings is kept, bends of the first and second connection piece strings are restricted by each other, and thereby the columnar body by joining of the first and second connection piece strings includes fixed rigidity. The arm section 5 is sent out toward outside from the opening at the front of the rise/fall section 4 linearly along the axis of movement RA3. When the drive gear rotates reversely, the arm section 5 retracts. When the arm section 5 retracts, the arm section 5 is returned to the opening on the front part of the ejection section. The returned arm section 5 is separated into the first and second connection piece strings at the rear part of the ejection section. The separated first and second connection piece strings respectively return to the bendable state, and are stored in the storage section mutually along the axis of rotation RA1.

The wrist section 6 is attached to a tip of the arm section 5. The wrist section 6 houses the fourth, fifth and sixth joints J4, J5 and J6. A fixed section of the fourth joint J4 is attached to a tip of the arm section 5. A rotating section of the fourth joint J4 is connected rotatably around the axis of rotation RA4 to the fixed section. A fixed section of the fifth joint J5 is connected to the rotating section of the fourth joint J4. A rotating section of the fifth joint J5 is connected rotatably around the axis of rotation RA5 to the fixed section. A fixed portion of the sixth joint J6 is connected to the rotating section of the fifth joint J5. A rotating section of the sixth joint J6 is connected rotatably around the axis of rotation RA6 to the fixed section. The rotating section of the fourth joint J4 is covered with a cylindrical housing 61. The cylindrical housing 61 is disposed so that a center axis of the housing 61 is parallel with the axis of rotation RA4. The fixed section of the fifth joint J5 is covered with a cylindrical housing 63. The cylindrical housing 63 is disposed so that a center axis of the housing 63 is parallel with the axis of rotation RA5. The housing 61 with which the rotating section of the fourth joint J4 is covered, and the housing 63 with which the fixed section of the fifth joint J5 is covered are integrally molded, and interiors thereof communicate with each other. In the integrated housing, a motor that drives the fourth joint J4, a motor driver that controls the motor, a motor that drives the fifth joint J5 and a motor driver that controls the motor are housed. Further, the rotating section of the fifth joint J5 is covered with a saddle-shaped (U-shaped) housing 65. A fixed section of the sixth joint J6 is covered with a cylindrical housing 67. The housing 65 that covers the rotating section of the fifth joint J5, and the housing 67 that covers the fixed section of the sixth joint J6 are integrally molded, and interiors thereof communicate with each other. In the cylindrical housing 67, a motor that drives the sixth joint J6 and a motor driver that controls the motor are housed.

An adapter is provided at a rotating section of the sixth joint J6. An end effecter is attached to the adapter. The end effecter is moved to an arbitrary position by the first, second, and third joints J1, J2 and J3, and is disposed in an arbitrary posture by the fourth, fifth and sixth joints J4, J5 and J6. In particular, a length of an extension and retraction distance of the arm section 5 of the third joint J3 enables the end effecter to reach an object in a wide range from a position close to the base 1 to a position far from the base 1. The third joint J3 is characterized by a linear extension and retraction movement realized by the linear extension and retraction mechanism which constitutes the third joint J3 and the length of the extension and retraction distance thereof.

### (Air Cooling Mechanism)

The robot arm mechanism according to the present embodiment houses motor units (the motors and the motor drivers) in vicinities of the respective joints. The robot arm mechanism according to the present embodiment includes an air cooling mechanism for countermeasures against heat of these motor units. The robot arm mechanism according to the present embodiment has an intake port for taking in outside air, and an exhaust port for releasing the air which is taken in to outside after passing the air which is taken in through the motor unit, as the air cooling mechanism. The intake port and the exhaust port are disposed so that an influence on a workpiece which is an object of work by the robot arm mechanism is minimized.

The robot arm mechanism according to the present embodiment has no elbow joint and no singularity, so that it is not necessary to perform abrupt elbow joint rotation, turning motion and the like for avoiding singularities, and the arm section 5 moves in a linear trajectory between the wrist section 6 and the base 1. These things facilitate prediction of the motion of the robot by a surrounding worker or the like, and thereby safety of the robot is high. Accordingly, the robotic apparatus equipped with the robot arm mechanism according to the present embodiment can be disposed in the vicinity of a worker, and can be allowed to work in cooperation with the worker. For example, the robot apparatus is disposed in the vicinity of a conveyor device, picks up a workpiece passing on a conveyor, delivers the workpiece which is picked up to a nearby worker, and returns another workpiece worked by the worker to the conveyor. In this way, the robot arm mechanism according to the present embodiment is assumed to be disposed in the vicinity of the worker as the robot apparatus for picking. For example, when the workpiece is food or the like, air is desirably discharged rearward and upward of the robot arm mechanism, in order to avoid quality reduction caused by the air discharged from the robotic apparatus hitting the workpiece, and in order to avoid a light workpiece from dropping from the conveyor by the air discharged from the robotic apparatus. Rearward herein refers to an opposite direction to the direction in which the arm section 5 extends. Further, in order that the clothing of the nearby worker is not sucked in, the intake port is desirably provided in a position which the worker cannot approach or a position where an influence on the worker is small even when clothing is sucked in.

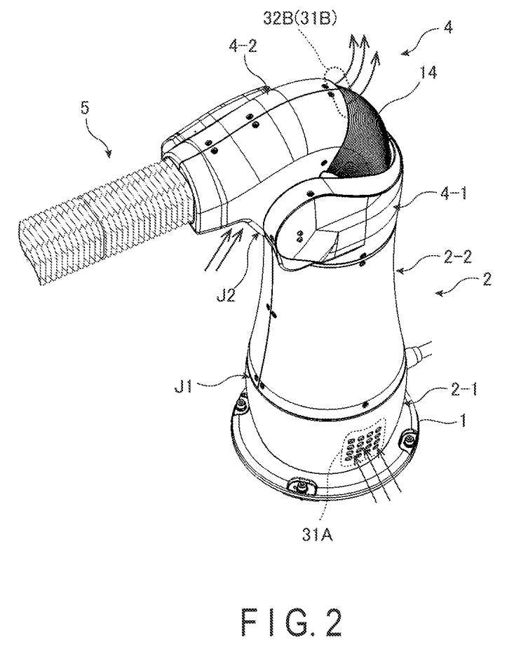

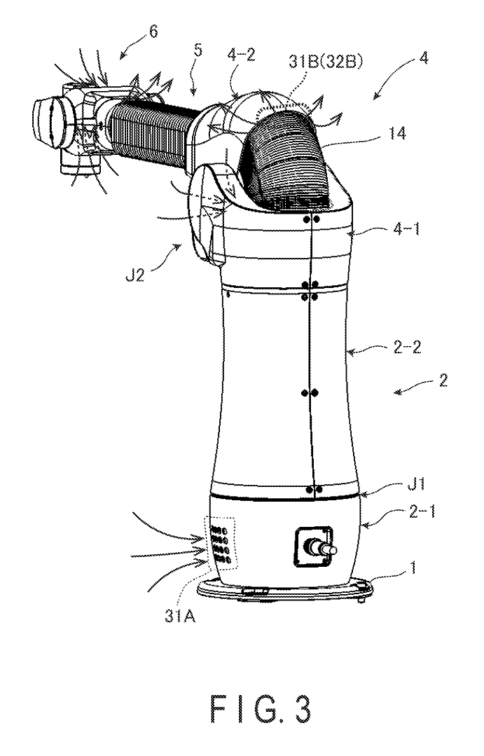

Specifically, as illustrated in FIG. 2 and FIG. 3, a plurality of holes are opened as a first intake port 31A on a cylinder circumferential surface of the cylindrical housing of the lower section 2-1 of the column section 2. As a first exhaust port 31B that discharges the air that is taken in from the first intake port 31A, a space is formed between a rear end of the housing with which the front section 4-2 of the rise/fall section 4 is covered, and the cover. In a hollow portion formed by the column section 2 and the rise/fall section 4, a first air passage route for the air taken in from the first intake port 31A to pass through at least the motor unit of the first joint J1 and to be discharged from the first exhaust port 31B is formed. An intake fan is provided on the first air passage route, preferably, inside the first intake port 31A. The air that is taken in from the first intake port 31A cools at least the motor unit of the first joint J1 and is discharged from the first exhaust port 31B. The first air passage route may be formed to pass through the respective motor units of the first, second and third joints. Providing the first intake port 31A in the vicinity of a bottom of the robot arm mechanism reduces the possibility of sucking in the clothing of the worker and the works flowing on the conveyor.

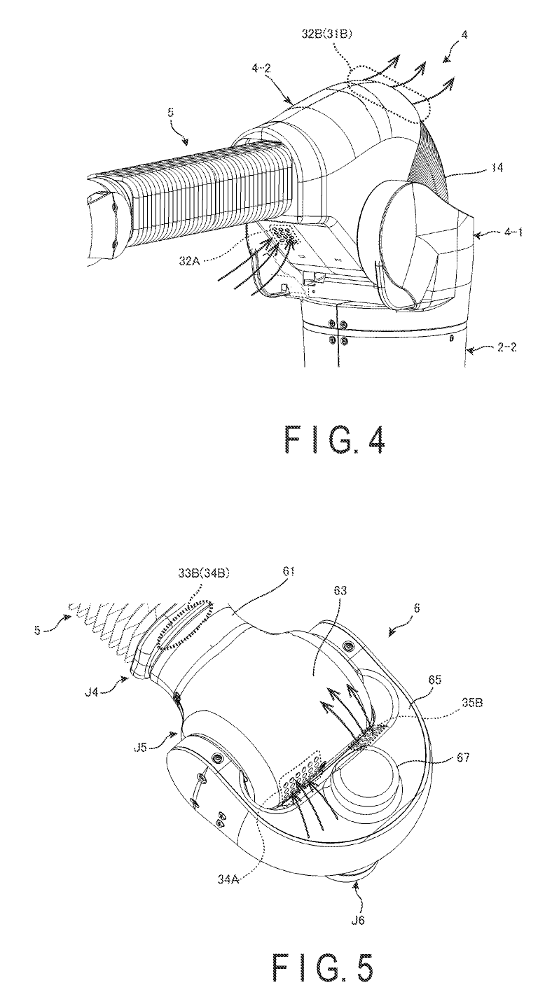

As illustrated in FIG. 4, a plurality of holes are opened as a second intake port. 32A in a lower portion of the cylindrical housing of the front section 4-2 of the rise/fall section 4. A second exhaust port 32B that discharges the air taken in from the second intake port 32A is also used as the above described first exhaust port 31B. In a hollow portion formed by the column section 2 and the rise/fall section 4, a second air passage route for the air that is taken in from the second intake port 32A to pass through at least the motor unit of the second joint J2 and to be discharged from the second exhaust port 32B (the first exhaust port 31B) is formed. An intake fan for taking in air from the second intake port 32A and passing the air which is taken in, rearward is provided on the second air passage route, preferably, inside the second intake port 32A. The air which is taken in from the second intake port 32A cools at least the motor unit of the second joint J2, and is discharged from the second exhaust port 32B. The second air passage route may be formed to pass through the respective motor units of the second and third joints. A lower part of the housing of the front section 4-2 of the rise/fall section 4 is a place where the worker is hard to enter. Consequently, providing the second intake port 32A in the lower portion of the housing of the front section 4-2 of the rise/fall section 4 reduces the possibility of the clothing of the worker being sucked in. Further, as the first exhaust port 31B (the exhaust port), forming the space between the rear end of the housing with which the front section 4-2 of the rise/fall section 4 is covered, and the cover, and discharging the air that is taken in from the first and second intake ports 32A upward to the rear from the space reduce the possibility of the discharged air being emitted to the workpiece, whereby an influence on the workpiece is minimized. The port section denoted by reference sign “31A” opened in the lower section 2-1 of the column section 2 is described as the intake port in the above description, but may be an exhaust port. In this case, the intake air taken in from the second intake port 32A passes through the hollow portion formed by the column section 2 and the rise/fall section 4, cools the motor unit of the first joint J1 and is discharged from the exhaust port 31A. An exhaust fan is preferably installed inside the exhaust port 31A.

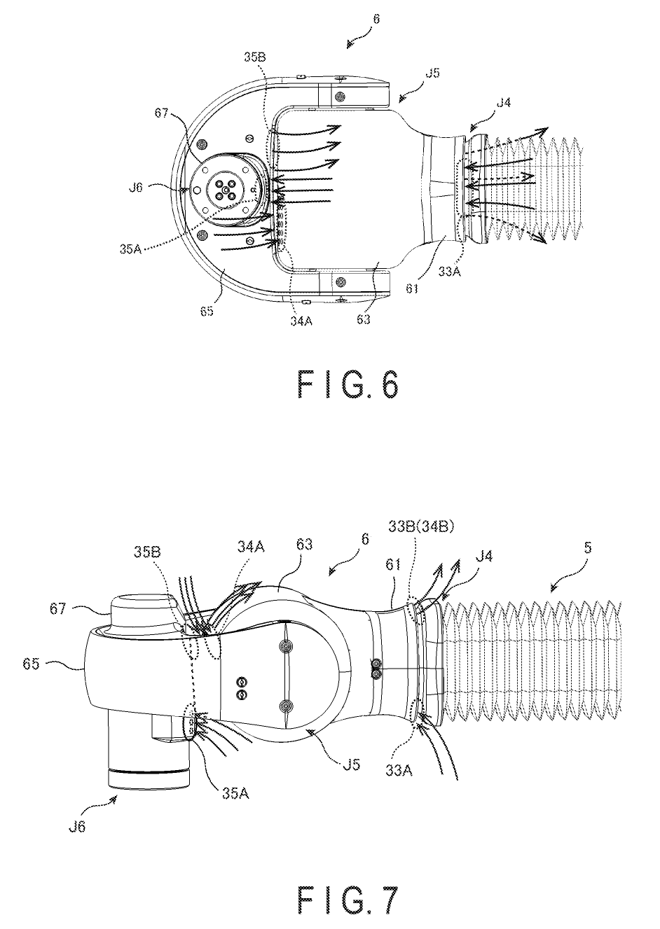

FIG. 5 is a detailed view of the wrist section 6 in FIG. 1. FIG. 6 is a view of the wrist section 6 in FIG. 5 seen from an attaching section side of the end effecter. FIG. 7 is a view of the wrist section 6 in FIG. 5 seen from a side. In the wrist section 6, an intake port is provided at a side close to the end effecter which is attached to the rotating section of the sixth joint J6, and an exhaust port is provided at a side far from the end effecter, respectively.

Specifically, a space is formed as a third intake port. 33A between a rear end lower portion of the housing 61 with which the fourth joint J4 is covered, and a tip lower portion of the housing of the arm section 5. As a third exhaust port 33B that discharges the air which is taken in from the third intake port 33A, a space is formed between the rear end upper portion of the housing 61 with which the fourth joint J4 is covered, and the tip upper portion of the housing of the arm section 5. Inside the integrated type housing with which the rotating section of the fourth joint J4 and the fixed section of the fifth joint J5 are covered, a third air passage route for the air taken in from the third intake port 33A to pass through at least the motor unit of the fourth joint J4 and to be discharged from the third exhaust port 33B is formed. An intake fan for taking in air from the third intake port 33A and passing the air which is taken in, upward is provided on the third air passage route, preferably, inside the third intake port 33A. The air taken in from the third intake port 33A cools at least the motor unit of the fourth joint J4 and is discharged from the third exhaust port 33B. The third air passage route may be formed to pass through the motor unit of the fifth joint J5 in addition to the motor unit of the fourth joint J4.

Further, a plurality of holes are opened as a fourth intake port 34A, on a front part of a cylinder circumferential surface of the cylindrical housing 63 with which the fixed portion of the fifth joint J5 is covered. A fourth exhaust port 34B that discharge air taken in from the fourth intake port. 34A is also used as the above described third exhaust port 33B. Inside the integrated type housing with which the rotating section of the fourth joint J4 and the fixed portion of the fifth joint J5 are covered, a fourth air passage route for the air that is taken in from the fourth intake port 34A to pass through at least the motor unit of the fifth joint J5 and to be discharged from the fourth exhaust port 34B is formed. An intake fan for taking in air from the fourth intake port 34A, and passing the air which is taken in, rearward is provided on the fourth air passage route, preferably, inside the fourth intake port 34A. The air that is taken in from the fourth intake port. 34A cools at least the motor unit of the fifth joint J5, and is discharged from the fourth exhaust port 34B. The fourth air passage route may be formed to pass through the motor unit of the fourth joint J4 in addition to the motor unit of the fifth joint J5.

Further, a plurality of holes are opened as a fifth intake port 35A, on a rear part of a cylinder circumferential surface, at a lower portion of the substantially cylindrical housing 67 with which the fixed section of the sixth joint J6 is covered. A plurality of holes are opened as a fifth exhaust port 35B on a rear part of a cylinder circumferential surface at an upper portion of the cylindrical housing 67 with which the fixed section of the sixth joint J6 is covered, in order that air that is taken in from the fifth intake port 35A is discharged in a direction away from the end effecter along an upper circumferential surface of the cylindrical housing 63 with which the fixed section of the fifth joint J5 is covered. Inside the integrated type housing with which the rotating section of the fifth joint J5 and the fixed section of the sixth joint J6 are covered, a fifth air passage route for the air that is taken in from the fifth intake port 35A to pass through the motor unit of the sixth joint J6 and to be discharged from the fifth exhaust port 35B is formed. An intake fan for taking in air from the fifth intake port 35A, and passing the air that is taken in, upward is provided on the fifth air passage route, preferably, inside the fifth intake port 35A. The air that is taken in from the fifth intake port 35A cools at least the motor unit of the sixth joint J6, and is discharged from the fifth exhaust port 35B.

As described above, in the wrist section 6, providing the third, fourth and fifth exhaust ports 35B on the rear parts of the upper portions of the respective housings reduces a possibility of the discharged air being emitted to the workpiece. In particular, forming the housing 63 with which the fixed section of the fifth joint J5 is covered cylindrically, and providing the fifth exhaust port 35B on the rear part of the upper portion of the cylindrical housing 67 with which the sixth joint J6 is covered guide most of the air discharged from the fifth exhaust port 35B upward to the rear of the robot arm mechanism along the cylinder circumferential surface of the cylindrical housing 63 with which the fixed section of the fifth joint J5 is covered even when the end effecter is raised and lowered by rotation of the fifth joint J5, so that an influence on the workpiece can be minimized. The fifth exhaust port 35B is provided to be offset with respect to the fourth intake port 34A with respect to the direction parallel with the axis of rotation RA5. This decreases an amount of warm air that is discharged from the fifth exhaust port. 35B and is taken in from the fourth intake port 34A, and enhances air cooling efficiency.

Further, the first to fifth air passage routes described in the above may be cylindrical passage routes for only passing air to the motor units that are objects to be air-cooled, or may be passage routes that are formed so that air passes through the motor units that are objects resultantly by restricting the direction in which the air which is taken in flows by disposition of the components constituting the robot arm mechanism and disposition of partition plates.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 . . . Base, 2 . . . Column section, 4 . . . Rise/fall section 5 . . . Arm section, 6 . . . Wrist section, 31A . . . First intake port, 31B . . . First exhaust port, 32A . . . Second intake port, 32B . . . Second exhaust port, 33A . . . Third intake port. 33B . . . Third exhaust port, 34A . . . Fourth intake port, 34B . . . Fourth exhaust port, 35A . . . Fifth intake port, 35B . . . Fifth exhaust port

1. A robot arm mechanism in which a column section is rotatably supported on a base, a rise/fall section is placed on the column section, an arm including expansion and contraction properties is supported by the rise/fall section to be capable of raising and lowering, and a wrist section to which an end effecter is fittable is mounted to a tip of the arm,
wherein in the rise/fall section, a intake port is provided in a front part and a exhaust port is provided in a rear part, separately, and
in the wrist section, a intake port is provided at a side close to the end effecter, and a exhaust port is provided at a side far from the end effecter, separately.

2. The robot arm mechanism according to claim 1,
wherein the wrist section includes a first torsional rotation joint that is connected to the tip of the arm, a bending rotation joint that is connected to a rotating section of the first torsional rotation joint, and a second torsional rotation joint in which an attaching section for the end effecter, of the bending rotation joint is mounted to a tip, and
a intake port is placed on a rear part of a circumferential surface of a substantially cylindrical housing with which the second torsional rotation joint is covered, and a exhaust port is placed in a position where air that is taken in from the intake port placed on the cylindrical housing is discharged in a direction away from the end effecter along an upper circumferential surface of a substantially cylindrical housing with which a fixed section of the bending rotation joint is covered.

3. The robot arm mechanism according to claim 2,
wherein a intake port is placed in a front part of the circumferential surface of the substantially cylindrical housing with which the fixed section of the bending rotation joint is covered, and air that is taken in from the intake port is discharged rearward from a space between a tip of a housing with which the arm is covered, and a rear end of a housing with which the first torsional rotation joint is covered.
